(19) United States
(12) Patent Application Publication
(10) Pub. No.: US 2025/0229871 A1
(43) Pub. Date: Jul. 17, 2025

(54) RACK ADAPTED TO SECURE A HOSE FOR FACILITATING THE TRANSFER OF MATERIAL TO AND FROM WATER BORNE PLATFORMS AND VESSELS

(71) Applicant: Red Skies Offshore LLC, Tomball, TX (US)

(72) Inventors: Geoffrey Michael McCann, Tomball, TX (US); Luke Woolley, Pinehurst, TX (US)

(73) Assignee: Red Skies Offshore LLC, Tomball, TX (US)

(21) Appl. No.: 19/013,150

(22) Filed: Jan. 8, 2025

Related U.S. Application Data
(60) Provisional application No. 63/619,791, filed on Jan. 11, 2024.

(51) Int. Cl. B63B 27/34; F16L 3/12

(52) U.S. Cl. CPC B63B 27/34; F16L 3/1226

(57) ABSTRACT

A rack is provided for securely, but removably, connecting an elongate article (e.g., a conduit or hose) to an elongated apparatus (e.g., a horizontal beam or railing) of a water borne platform or vessel during transfer of fluids and flowable materials through the conduit. In an exemplary embodiment, the rack includes a mounting frame which rests on and grips the beam, thereby fixing the position of the rack on the beam. The rack also includes a cradle affixed to the top of the frame and a clasp assembly affixed to the front of the frame. The cradle receives, orients, and supports the hose lying substantially transversely across the beam, and the clasp holds the hose on the rack. Additional features are provided which enhance safety and enable use of the rack in different environments and industries.

### CROSS-REFERENCE TO RELATED APPLICATIONS

The present application claims the benefit of U.S. Provisional Application No. 63/619,791 filed on Jan. 11, 2024, the entire disclosure of which is hereby incorporated by reference herein.

### FIELD OF THE INVENTION

The invention described and contemplated herein relates to a device for securely and removably holding and securing a flexible conduit, hose, or other elongate article, to a beam, railing, or other elongated apparatus, of a water borne platform or vessel, thereby limiting unwanted movement of the hose during transfer of fluids and flowable materials to and from water borne platforms and vessels.

### BACKGROUND

Offshore platforms, mobile offshore drilling units (MODUs), or really any equipment or vessel that requires or uses power, often receive fuel oil delivered by a water borne vessel of some kind, such as an offshore supply vessel (OSV), through one or more transfer hoses. Depending on the nature and size of operations, as well as location and conditions there, transfer hoses may vary in diameter, such as from 2 inches to 8 inches. In the Gulf of Mexico, 4 to 5-inch diameter transfer hoses are typically used. In the offshore drilling sector, fluids other than fuel oil, such as water, liquid mud, base oil, etc., are also sent through these hoses. Additionally, flowable materials and bulk products, such as barite and cement, may also be transferred through such transfer hoses, for example, compressed air. Of course, such transfer hoses are also useful in industries other than oil and gas production, where there is a need to deliver and transfer fluids and flowable materials to and from water borne vessels.

Sometimes a device or feature is provided on or with a transfer hose to assist with engaging and moving the transfer hose, using a crane (for example, positioned on an offshore platform), to an OSV or other water borne vessel which is carrying and delivering fluid or flowable materials to the platform. For example, a transfer hose may include a feature or section on or near the end of the hose, such as an external “eye,” which is sized and shaped for receiving the hook of a crane therein to engage and move the end of the transfer hose onto an OSV. As another example, a wire or cord having an eye at each of its two ends (sometimes referred to as a “stinger”) may be wrapped around a hose, at or near one end of the hose, such that the eyes may be aligned to concurrently receive a hook of a crane therethrough for engaging and moving the end of the transfer hose to an OSV.

After one end of the hose is engaged and moved (e.g., lowered) to an OSV (Offshore Supply Vessel) or other vessel carrying liquid or fluid materials for transfer, the hose is typically draped or laid over or across (e.g., across the top of) an elongate support feature on the OSV or other vessel, and affixed in some way to minimize movement during transfer of the fluid or flowable materials. Such support features tend to be elongated apparatus and oriented horizontally or sloped rather than vertically. For instance, many water borne vessels, such as OSVs, have a horizontal bar or beam which extends at least part way across the back deck of the vessel. This beam is sometimes referred to as a “headache rack.” Other elongated apparatus (support features) provided on delivery vessels which have been useful for resting and securing a transfer hose while fluid or flowable materials are delivered through the hose include bulkhead rims, deck railings, etc.

Once the hose is situated across a support feature where the supply vessel personnel want it, the hose is then typically connected to the supply vessel by tying it with ropes or cords (e.g., one or more manila or synthetic lines, etc.) to one or more stanchions or pad eyes located on the deck of the supply vessel. This is done to prevent or minimize slipping of the hose along or off the support feature during transfer operations. Slipping and movement of the transfer hose relative to the support feature may be caused by several circumstances, including but not limited to, handling of other portions of the transfer hose which cause movement near the support feature, movement of personnel and/or equipment or other items on deck near the transfer hose, and movement of the water borne vessel (whether intentional, such as careless or accidental operation of the vessel during transfer of fluids or flowable material, or unintentional, such as wave action of the body of water in which the vessel sits). The unintended movement, slipping, rubbing, and chafing of the transfer hose by such circumstances can and often does, in turn, cause any one or more of several undesirable and/or dangerous occurrences including, without limitation, damage to couplings (e.g., “TODO” dry-break couplings) and other devices affixed on the transfer hose, damage to the supply vessel's manifold, activating dry-break couplings often provided in the middle of hydrocarbon transfer hoses, or even all of the aforementioned occurrences.

Connecting transfer hoses to a supply vessels as described above, i.e., by draping over support features and tying it with manila or synthetic lines, has been satisfactory and relatively successful for years, but does not eliminate all unintentional movement, rubbing, chafing, and damage caused thereby and, therefore, is not without its disadvantages. For example, in the offshore oil and gas industry, time is money, and this method takes a significant amount of time to implement. Furthermore, reliability is important for safety and other concerns and this method of tying the transfer hose with manila or synthetic lines is not always effective.

Furthermore, there have been many instances in which a manila line used to tie a transfer hose in place across a support feature on a water borne vessel has damaged the transfer hose, or sections thereof, to the point where the hose has been rendered unsafe, inoperable, or both. In practice in the offshore oil and gas industry, if a transfer hose or fittings thereon are damaged, use of that hose must be immediately discontinued and the hose must be taken out of service, be removed from the rig or platform, and either be sent in for repair and recertification or entirely discarded (i.e., if beyond effective or economically justified repair). All of the foregoing consequences which flow from damaged transfer hoses and/or their fittings are costly in the form of money, time, and personnel safety.

There are two additional disadvantages to the above-described currently practiced methods for handling and connecting transfer hoses to water borne vessels for transfering fluid and flowable materials to and from water borne platforms and vessels. The first additional disadvantage is that, over a tranfer hose's in-service time and in between recertifications, it will go through numerous transfer evolutions. More specifically, with each use of a hose for successive transfer operations, a particular section of that hose is often rested on the support feature again and again, repeatedly. Furthermore, another section or sections of the transfer hose (i.e., different from the section which rests on the support feature headache rack) is tied with manila line or other rope or cord, to the deck of the water borne vessel. These circumstances, in which certain sections are repeatedly used and subjected to the same damaging forces and conditions, often result in the aforesaid sections of the hose beginning to wear more than the rest of the hose which, in turn, will cause the protective outer coating typically provided on transfer hoses to become thinner and uneven and eventually wear off entirely. Typically, when enough of the protective outer coating is worn off so that fibers of the transfer hose are visible to the eye, sufficient damage to the hose has occurred that removal from service is warranted. Once this happens, the personnel on the supply vessel are required to notify the offshore platform management and reject use of the damaged transfer hose after discovery of such conditions. Additionally, the above-described repeated use and stress on specific sections of a transfer hose will also often more persistently bend, crimp, or fold those sections which weakens the wall of the hose at those sections and increases the likelihood of failure at those sections.

The second additional disadvantage is that the above-described currently practiced method for connecting a transfer hose to a supply vessel requires personel on the supply vessel to have their hands between the hose and the manila line numerous times which allows more opportunity for bodily injury to occur. Hand safety is a very high priority in the offshore oil and gas industry, and other industries involving transfer of flowable materials to and from water borne platforms and vessels.

Furthermore, if any one or more of several events occurs such as, without limitation, arrival of a cold front, an isolated weather event, or a dynamic positioning (DP) event, movement of the hose relative to the supply vessel and its support feature (e.g., headache bar) may result in damage to the hose and its couplings and other fixtures, as well as to one or both of the water borne offshore platform and vessel. DP events include, but are not limited to, movement of a water borne platform or vessel due to wave action or other water movements, as well as failure of one or more electronics devices or systems such as a GPS system, wind sensors, etc. Additionally, injuries to personnel of one or both of the water borne platform and vessel are also commonly caused by such uncontrollable events. Sometimes such damage and injuries can be reduced or avoided if the manila lines holding the hose can be quickly untied or otherwise undone. However, pocket knives have become a thing of the past on offshore platforms and supply vessels due to concerns for hand safety. With personal knives not being allowed on offshore installations, a different quick solution is necessary to provide fast, easy, and most importantly, safe, ways to detaching transfer hoses from supply vessels.

The invention described and contemplated below provides several features which address and resolve the aforesaid issues, risks, and concerns.

### SUMMARY OF THE INVENTION

A rack for supporting and securing an elongate article on an elongated apparatus of a water borne vessel is provided for transferring materials to and from one or more sources and destinations, at least one of which comprises the water borne vessel. The elongate article to be held and secured on the rack may, for example without limitation, be a flexible conduit, a hose, a cord, a cable, a tube, and an electric cord, and a power cable. The rack may be secured on an elongated apparatus such as, without limitation, a beam, a bar, a rack, a railing, and a top rim of a wall, fence, bulkhead, panel, or partition.

Generally, the rack comprises: a mounting frame, a cradle, and a clasp assembly, wherein the mounting frame has a top and includes at least one rear element extending downward from the top and at least one front element extending downward from the top and spaced from the at least one rear element, the mounting frame being sized and shaped to enable the top to rest on the elongated apparatus while the at least one rear element extends downward on one side of the elongated apparatus and the at least one front element extends downward on an opposite side of the elongated apparatus. The cradle is sized and shaped to receive and support the elongate article while lying substantially transversely across the elongated apparatus, the cradle being affixed to the top of the mounting frame and including movement limiting elements which limit sideways movement of the elongate article while supported thereon. The clasp assembly which is affixed to and extends from a front of the mounting frame for receiving and holding the elongate article and reducing movement of the elongate article while lying substantially transversely across the elongated apparatus.

The mounting frame may comprise: a first inverted U-shaped bar having a rear leg, a front leg, and a transverse arm connecting the rear and front legs of the first inverted U-shaped bar, and a second inverted U-shaped bar which is spaced from and aligned with the first inverted U-shaped bar, the second inverted U-shaped bar having a rear leg, a front leg, and a transverse arm connecting the rear and front legs of the second inverted U-shaped bar. Furthermore, when the rack is in use, the transverse arms of both of the first and second inverse U-shaped bars rest on the elongated apparatus, the at least one rear element of the mounting frame comprises the rear legs of both of the first and second inverted U-shaped bars which both extend downward on one side of the elongated apparatus, and the at least one front element of the mounting frame comprises the front legs of each of the first and second inverted U-shaped bars, the front legs extending downward on an opposite side of the elongated apparatus.

The mounting frame may further include one or more moveable securing features which contact and grip an elongated apparatus when the hose rack is mounted thereon, wherein each of the one or more moveable securing features is moveably affixed to the mounting frame, on an inner surface of a respective one of the rear leg, the front leg, or the transverse arm of either the first inverted U-shaped bar or the second inverted U-shaped bar, by at least one guide pin attached to the moveable securing feature and inserted through the respective one of the rear leg, the front leg, or the transverse arm to which the moveable securing feature is moveably affixed, wherein each of the one or more moveable securing features is adjustable, relative to the respective one of the rear leg, the front leg, or the transverse arm to which it is moveably connected, by at least one forcing screw which is in contact with the moveable securing feature and inserted through the respective one of the rear leg, the front leg, or the transverse arm to which it is moveably connected, wherein each of the one or more moveable securing features is adjustable, relative to the respective one of the rear leg, the front leg, or the transverse arm to which it is moveably connected, by at least one forcing screw which is in contact with the moveable securing feature and inserted through the respective one of the rear leg, the front leg, or the transverse arm to which it is moveably connected, and wherein when a forcing screw is operated to adjust the position of its respective movable securing feature closer to an elongated apparatus on which the rack is being mounted, the moveable securing feature will apply force against, and increase friction with, the elongated apparatus and retain the rack in a selected position on the elongated apparatus during its use. At least one of the moveable securing features may comprise a rubber pad having one or more shaped sections selected from a flat section, a convex section, or a combination thereof, for enabling securely mounting the rack to elongated apparatuses having any of various shapes and sizes.

Furthermore, the one or more moveable securing features may comprise a plurality of movable security features, each of which comprises a rubber pad having at least: a first flat end section at one end thereof, a second flat end section at an opposite end thereof, and an intermediate convex section between the first and second flat sections, wherein the plurality of movable security features includes one or more of: (a) a first rubber pad which is moveably affixed on an inner surface of the rear leg of the first inverted U-shaped bar by at least one guide pin inserted through the rear leg of the first inverted U-shaped bar, and is adjustable by at least one forcing screw inserted through the rear leg of the first inverted U-shaped bar, (b) a second rubber pad which is moveably affixed on an inner surface of the rear leg of the second inverted U-shaped bar by at least one guide pin inserted through the rear leg of the second inverted U-shaped bar, and is adjustable by at least one forcing screw inserted through the rear leg of the second inverted U-shaped bar, (c) a third rubber pad which is moveably affixed on an inner surface of the front leg of the first inverted U-shaped bar by at least one guide pin inserted through the front leg of the first inverted U-shaped bar, and is adjustable by at least one forcing screw inserted through the front leg of the first inverted U-shaped bar, and (d) a fourth rubber pad which is moveably affixed on an inner surface of the front leg of the second inverted U-shaped bar by at least one guide pin inserted through the front leg of the second inverted U-shaped bar, and is adjustable by at least one forcing screw inserted through the front leg of the second inverted U-shaped bar.

The cradle may comprise a base which is attached to the top of the mounting frame and forms a support surface for supporting an elongate article thereon, and movement limiting elements comprising an upwardly sloping right wing affixed to and extending from one side of the base, and an upwardly sloping left wing affixed to and extending from an opposite side of the base. The base and the upwardly sloping right and left wings of the cradle are sized to allow the elongate article to rest on the support surface of the base, in between the right and left wings, and limit the sideways movement of the elongate article.

The base of the cradle includes a downward sloping back ramp extending from the support surface and a downward sloping front ramp extending from the support surface in a direction opposite from the back ramp, wherein the back ramp, support surface positioned intermediate the back and front ramps, and the front ramp together form a support path for an elongate article lying thereon, the support path providing additional support which reduces damage to the elongate article from bending too far while on the rack and minimizes stress on the rack. The support path of the cradle may have an angle or curvature which is as close as possible to an unstrained and natural curvature of the elongate article when on the cradle of the hose rack.

The clasp assembly may comprise: a downward sloping face which is oriented and sloped to provide additional support to an elongate article lying across and supported on the cradle, and at least one clasp arm, each of which has a pivot end pivotably attached to the downward sloping face and each of which is moveable between an open position and a closed position, each of the at least one clasp arms also having a free end opposite the pivot end and which is adapted for locking the at least one clasp arm in the closed position. When the at least one clasp arm is in its open position, an elongate article lying on and supported by the cradle also lies on and is supported by the downward sloping face. On the other hand, when the at least one clasp arm is in its closed position, the elongate article is securely held on the rack and its movement is limited relative to the rack.

In one embodiment, the at least one clasp arm includes a single clasp arm wherein the locking end includes a locking pin for locking the single clasp arm in its closed position. A pull strap attached to the locking pin may be provided for quick release of the locking pin and rapid movement of the single clasp arm to its open position.

In an alternative embodiment, the at least one clasp arm includes a first clasp arm, a second clasp arm, and a locking pin, wherein the respective pivot end of each of the first clasp arm and the second clasp arm is pivotably attached to the downward sloping face, the respective pivot end of each of the first clasp arm and the second clasp arm has a bore hole therethrough, and wherein, when the first and second clasp arms are both in their respective closed positions, the free ends of the first and second clasp arms mate and the bore holes align with one another and are sized and shaped to receive the locking pin through both bore holes, thereby locking the first and second clasp arms together in their closed positions.

### BRIEF DESCRIPTION OF THE FIGURES

The present invention will be further explained with reference to the attached drawings, wherein like structures are referred to by like numerals and/or letters throughout the several views. The drawings shown are not necessarily to scale, with emphasis instead generally being placed upon illustrating the principles of the present invention.

FIG. 1 is a front, right side, elevational perspective view of an exemplary embodiment of a hose rack in accordance the present invention and having a clamp arm in its closed position;

FIG. 2 is the front, right side, elevational perspective view of the hose rack of FIG. 1, but showing the open position of the clamp arm in phantom;

FIG. 3 is a front, right side, bottom perspective view of the hose rack of FIG. 2;

FIG. 4 is a back, right, elevational perspective view of the hose rack of FIG. 2;

FIG. 5 is a front elevational view of the hose rack of FIG. 2;

FIG. 6 is a right side elevational view of the hose rack of FIG. 2;

FIG. 7 is a top plan view of the hose rack of FIG. 2;

FIG. 8 is a bottom plan view of the hose rack of FIG. 2;

FIG. 9 is a front, right side, elevational perspective view of the hose rack of FIG. 2 in use, i.e., installed on a cylindrical bar (i.e., having a circular cross-section) and having a hose mounted thereon;

FIG. 10 is a front, right side, elevational perspective view of the hose rack of FIG. 2 in use, i.e., installed on a square bar (i.e., having a square cross-section) and having a hose mounted thereon;

FIG. 11 is a top plan view of the hose rack shown in use in FIG. 10, i.e., installed on a square bar and having a hose mounted thereon;

FIG. 12 is a right side elevational view of the hose rack shown in use in FIG. 10, i.e., installed on a square bar and having a hose mounted thereon;

FIG. 13 is a front, left side, elevational perspective view of another exemplary embodiment of a hose rack in accordance the present invention and having the clamp arms in their closed position;

FIG. 14 is a front elevational view of the hose rack of FIG. 13;

FIG. 15 is a left side elevational view of the hose rack of FIG. 13;

FIG. 16 is a right side elevational view of the hose rack of FIG. 13; and

FIG. 17 is a top plan view of the hose rack of FIG. 13.

### DETAILED DESCRIPTION

The invention described and contemplated herein comprises The invention described and contemplated herein relates to a device for securely and removably holding and securing a flexible conduit, hose, or other elongate article, to a beam, railing, or other elongated apparatus, of a water borne platform or vessel, thereby limiting unwanted movement of the hose during transfer of fluids and flowable materials to and from water borne platforms and vessels. In an exemplary embodiment, a hose rack is described which addresses and resolved the issues and concerns described above, while still keeping safety of users, operators and other personnel as the highest priority. More specifically, the hose rack enables secure attachment, as well as rapid detachment, of a flexible conduit (e.g., a hose) to an elongated apparatus (e.g., beam or railing) provided on water borne vessels, offshore platforms, or both, which, in turn, provides more secure and safer transfer of flowable materials, through the flexible conduit, to and from floating platforms and water borne vessels.

Generally, the hose rack has been developed having a modular design so that any parts or components may be individually replaced as needed, without having to replace the entire rack. The modular design of the rack is expected to make the rack useful to consumers and industry participants in a variety of contexts and environments.

A detailed description is provided hereinbelow of an exemplary embodiment of the hose rack of the present invention that is adapted for use in the oil and gas industry and particularly, to transfer flowable materials such as fuel, oil, water, cement, and mud, to and from offshore platforms and supply vessels, through a transfer hose. However, it should be understood that modifications to the rack and its various components will adapt the rack for effective use in other contexts and industries to secure and hold various types of elongate articles which could and do otherwise disadvantageously (or even dangerously) move and shift location and orientation. Rather, it is contemplated and expected that the rack of the present invention will be readily adaptable for use with any type of elongate article and equipment (e.g., flexible conduit, hose, cords, cables, etc.) and for the transfer of any of many kinds of flowable materials (i.e., fluids, particulate solids, fluidized solids, and combinations thereof) as in the case of conduits and hoses, as well as for the transfer or conduction of electricity, or compressed air, as in the case of power cords and air hoses, respectively.

In the maritime industry, the flexible conduit will often be a hose, but may also be a flexible tube, pipe, duct, or even some combination of these. As will be appreciated by persons of ordinary skill in the relevant art, the rack described and contemplated herein will be useful and advantageous in any of several possible situations wherein one or both of the source and destination between which fluid and/or flowable material are transferred through a flexible conduit (hose, tube, pipe, etc.) is susceptible to uncontrolled, sudden, or disruptive movement relative to the other. Such situations routinely, but not exclusively, arise in the context of transferring flowable materials such as fuel, oil, water, cement, and mud, to and from offshore platforms and supply vessels, through a transfer hose.

The flowable materials being transferred are not particularly limited. For example, flowable materials include, but are not limited to, one or more of: water, hydrocarbon fuel (liquid, oil, gaseous, etc.), crude oil and refined products thereof, drilling mud, mineral ore and refined products thereof, barite (or baryte), cement, gravel, grains, sand, and the like. Furthermore, compressed gas (e.g., neutral gas such as air or nitrogen) or other means for moving the flowable materials through the conduit may or may not be employed and is not particularly relevant to, or limited by, use of the hose rack described and contemplated herein.

It is further contemplated and expected that the hose rack of the present invention will be useful for connecting a hose used for transferring flowable materials to and from any type of offshore platforms and water borne vessels, any of which may be a source, a destination, or both, for the flowable material. Offshore platforms may be at least partially water borne or not. Water borne vessels at least partially float on a body of water and often entirely float on a body of water. Notably, one or more land-based containers or vehicles may also be a source, a destination, or both, for flowable materials being transferred to or from a water borne vessel. In other words, it is contemplated and expected that the hose rack will be useful and beneficial for supporting and holding a hose through which flowable materials are transferred from any source to any destination, where at least one of the source and destination is at least partially floating or water borne. Accordingly, the hose rack described and contemplated herein will be useful where at least one of the source and destination is an offshore platform or vessel that is at least partially water. Most often, but not always, the vessel will be a water borne vessel and the source of flowable material being transferred off the vessel to a destination.

The type of offshore platforms and water borne vessels from and to which flowable materials are transferred is not particularly limited by, or relevant to, use of the hose rack described and contemplated herein. Rather, water borne offshore platforms and water borne vessels include, without limitation, any apparatus, equipment, or vehicle which at least partially floats, or is otherwise disposed, on a body of water (e.g., ocean, gulf, sea, lake, pond, canal, river, etc.), regardless of the purpose or industry with which they are employed.

Offshore platforms which may be at least partially water borne include, for example without limitation, offshore oil and gas drilling platforms, mobile offshore drilling units and other platforms, piers, scaffolds, etc. While water borne platforms are often unattached, or freestanding, relative to land, they do not have to be, for purposes of this disclosure. Water borne platforms include, for example without limitation, ships, boats, and barges of all types, such as offshore supply vessels, cargo vessels, construction vessel, tanker vessels, drill ships, container ships, dry bulk carrier ships, and others.

As described below, an exemplary embodiment of the hose rack is adapted for and used to connect and hold a hose on an elongated apparatus or support feature of a water borne vessel during transfer of flowable materials from a water borne supply vessel, such as a ship, barge, etc. (a source), to an offshore oil and gas drilling platform or rig (a destination). In some embodiments, that support feature may be a generally horizontal beam or “headache rack” which is provided on a water borne vessel primarily to protect valves and personnel from swinging cargo during loading, but also useful for supporting a transfer hose during transfer of flowable materials.

For example, the hose rack will be useful for holding a hose during transfer of flowable material from any type of water borne platform (a source) to any type of water borne vessel (a destination), or between water borne vessels of the same or different types (e.g., from a ship to another ship, or from a ship to a barge or the reverse, etc.), or to and from one or more land-based containers, vehicles, or vessels (on shore or in “dry dock” condition) and one or more water borne vessels (e.g., from a source ship to a destination ship, from a ship to a barge or the reverse, from ship or barge to shore or the reverse, etc.), as well as other combinations of sources and destinations.

Additionally, as will be recognize by persons of ordinary skill in the relevant arts and industries, while the transfer of flowable materials has been and will be broadly described herein as between water borne platforms and vessels, as a practical matter, the flowable materials are typically transferred to and from one or more containers, one or more compartments, one or more other features, or combinations therefore, which are on, in, or a part of water borne platforms and vessels. Moreover, types of containers which may be affixed to, or removable from, the water borne platforms and vessels and include, without limitation, tanks, crates, cartons, silos, railcars, tanker trailers, truck trailers, and any other such apparatus or equipment which will contain the flowable materials being transferred. Compartments and other features of the water borne platforms and vessels that may or may not be integral thereto include, without limitation, fuel tanks, cargo holds, compartments, rooms, and the like.

All alternative embodiments and modifications of the hose rack for use with different types of flexible conduits, flowable materials, water borne platforms and vessels, and industries, are within the scope of the invention described and contemplated herein.

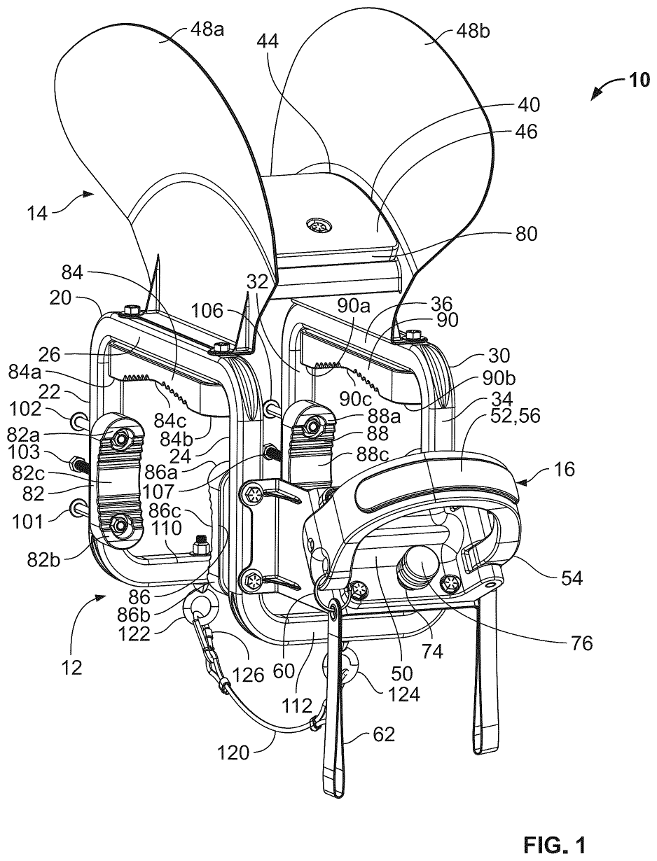

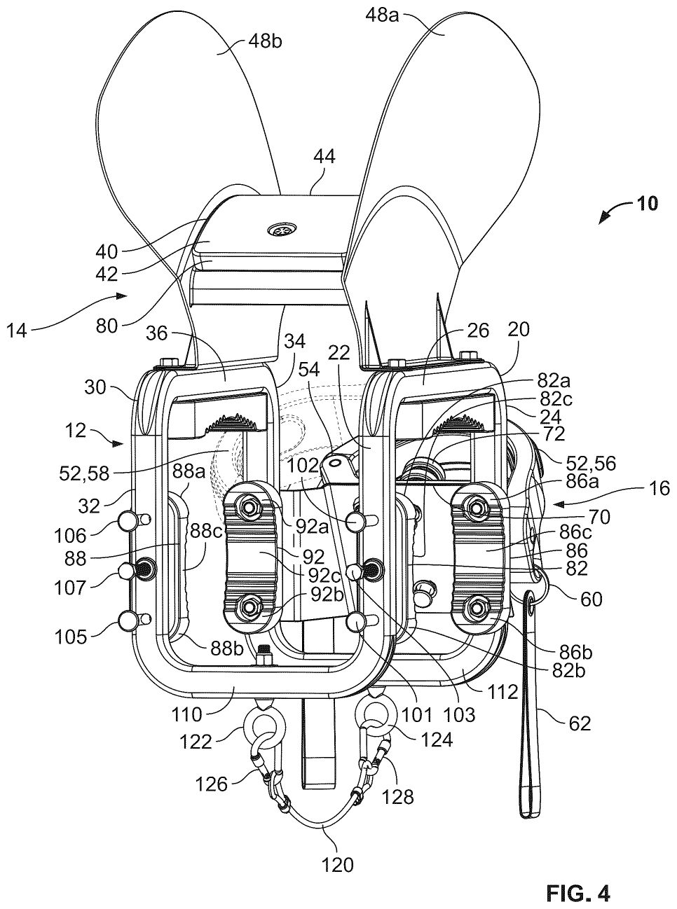

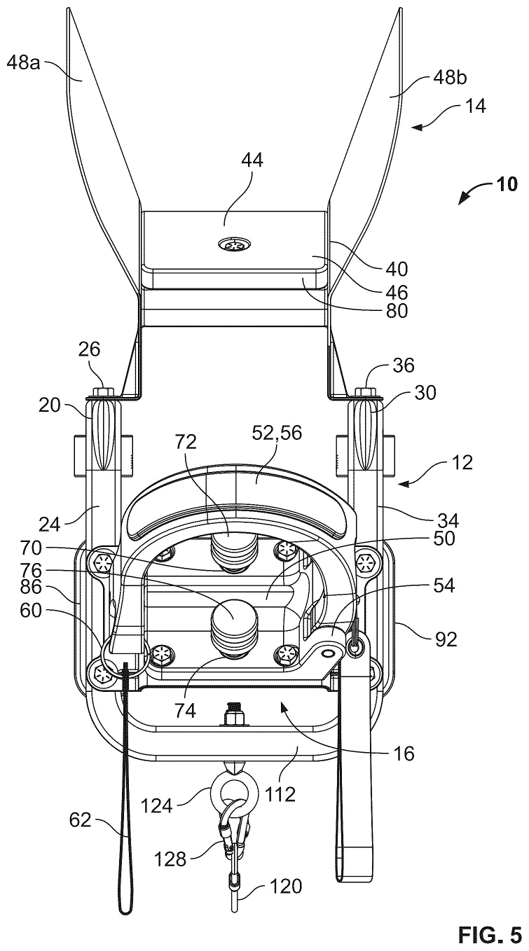

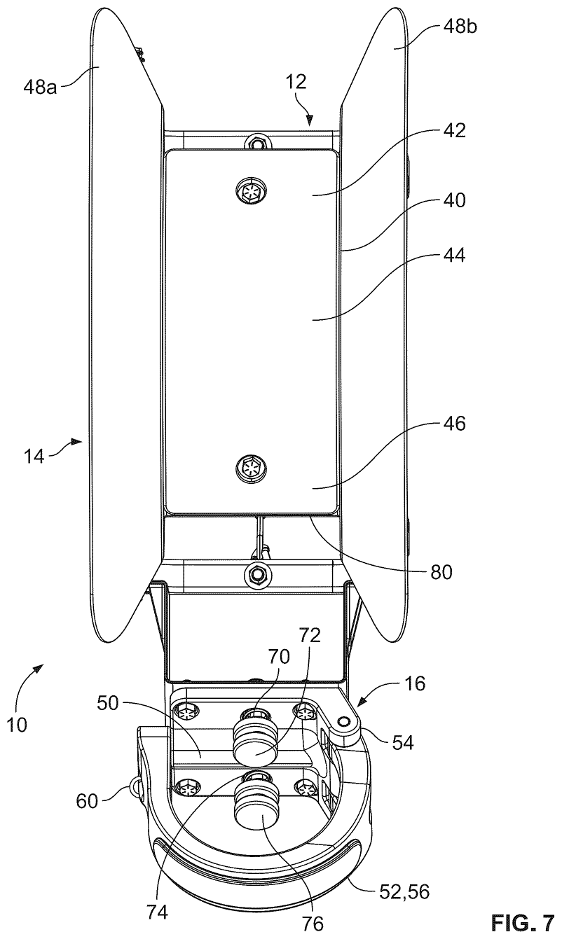

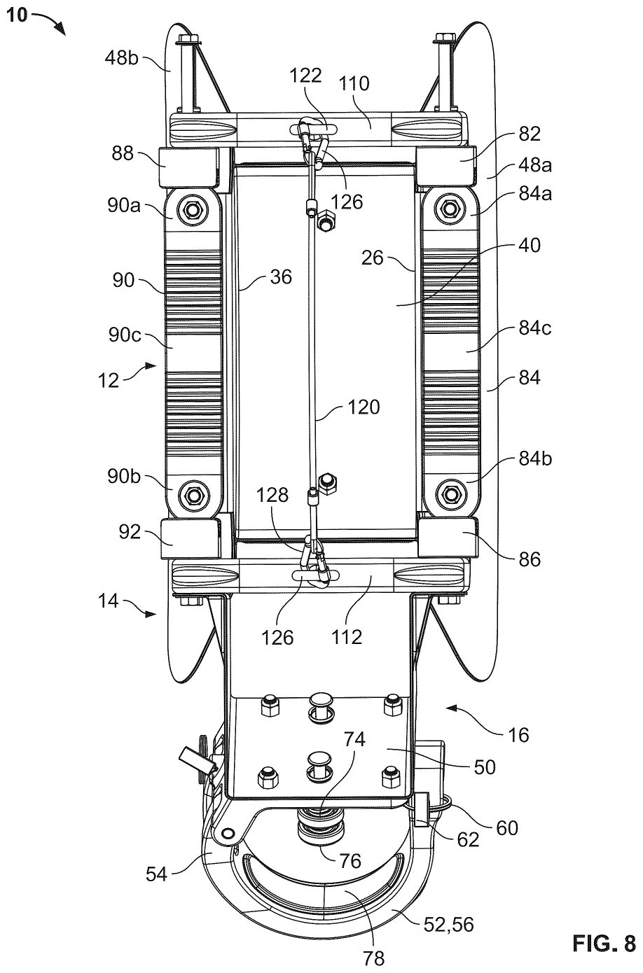

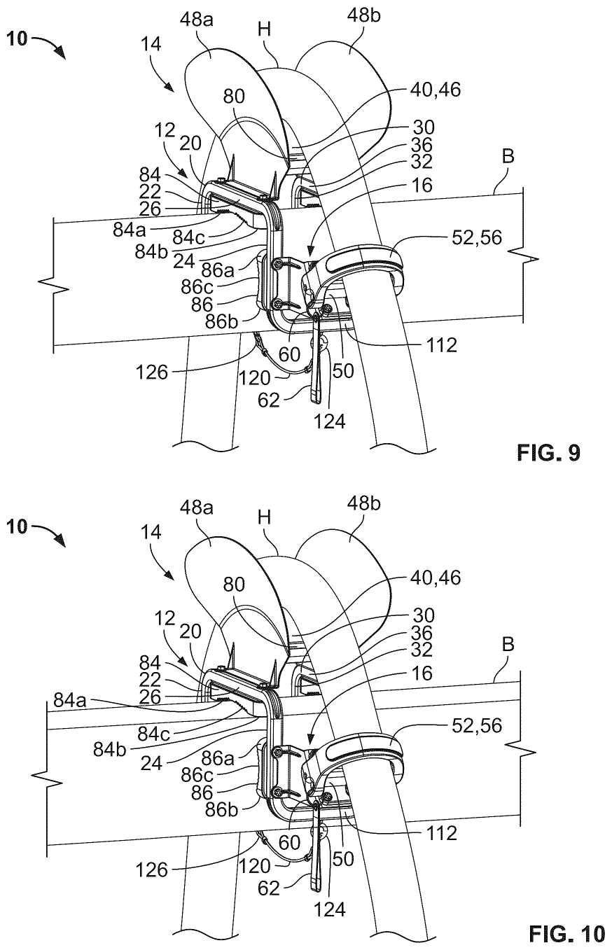

With reference now to FIGS. 1-8, the hose rack 10 includes several components which enable secure support and attachment, as well as rapid detachment, of a flexible conduit (e.g., a hose) to an elongated apparatus, such as the horizontal beam typically provided on offshore platforms, water borne vessels, or both. The hose rack 10 provides more secure and safer transfer of flowable materials (not shown), through the hose (H) (see FIGS. 9-12), to and from offshore platforms and water borne vessels.

As generally known and understood by persons of ordinary skill in the relevant art, the horizontal beam (B) is typically aligned with a railing of a water borne vessel or a peripheral edge of an offshore platform. From the point of view of an operator on the vessel or platform, there is a first side of the beam (B) which faces outwardly (i.e., away) from the deck of the vessel or platform and toward a body of water. Therefore, the aforesaid first side will be referred to herein as the water facing side of the beam (B). Opposite the water facing side there is an opposite, second side of the beam (B) which faces toward the vessel or platform (i.e., away from the body of water) and which is more easily accessible from the deck of the vessel or platform than the water facing side. Therefore, the aforesaid second side will be referred to herein as the deck side of the beam (B). It should be understood that, as an alternative or in addition to the headache rack, the railing of such a water borne vessel could provide an elongated apparatus on which the hose rack is mounted and secured for holding a securing the hose (H).

The hose rack 10 has a mounting frame 12 which is sized and shaped to rest on the horizontal beam (B), with at least one rear element and at least one front element both extending downward on opposite sides (i.e., simultaneously on the water facing side and on the deck side) of the horizontal beam (B) provided on a water borne vessel (or offshore platform). The shape of the beam (B) is not particularly limited and, as will be described in more detail later, the hose rack 10 has features which enable its use with differently shaped horizontal beams (B). For example, FIG. 9 shows the hose rack 10 mounted on a cylindrical beam (B) having a round cross-sectional shape, while FIGS. 10-12 show the hose rack 12 mounted on a non-cylindrical beam (B) having a square cross-sectional shape.

The hose rack 10 also includes a cradle 14 which is affixed to the top of the mounting frame 12 and which is sized and shaped to receive and support a hose (H) (see, e.g., FIGS. 9-12) which lies substantially transversely across the horizontal beam (B). Finally, the hose rack 10 includes a clasp assembly 16 affixed to and extending from the front of the mounting frame 12 for receiving and holding the hose (H).

As shown in the exemplary embodiment of FIGS. 1-8, the mounting frame 12 may be formed by a first inverted U-shaped bar 20 and a second inverted U-shaped bar 30 which is spaced from and aligned with the first inverted U-shaped bar 20. Referring briefly to FIGS. 9-12, the aforesaid orientation of the first and second inverted U-shaped bars 20, 30 enables the mounting frame 12 and, therefore, hose rack 10 to rest stably on the horizontal beam (B), with the rear legs 22, 32 (i.e., the above mentioned at least one rear element) of each of the first and second inverted U-shaped bars 20, 30, respectively, extending downward on one side, i.e., the water facing side, of the horizontal beam (B) and the front legs 24, 34 (i.e., the above mentioned at least one front element) of each of the first and second inverted U-shaped bars 20, 30, respectively, simultaneously extending downward on the opposite side, i.e., the deck side, of the horizontal beam (B). A transverse arm 26 connects the rear and front legs 22, 24 of the first inverted U-shaped bar 20, and another transverse arm 36 connects the rear and front legs 32, 34 of the second inverted U-shaped bar 30. When the hose rack is in use 10, each of the transverse arms 26, 36 rests across the top of the beam (B), and are spaced apart from one another. In the foregoing arrangement, the transverse arms 26, 36 define the top of the mounting frame 12.

The dimensions and spacing of the U-shaped bars 20, 30 may be varied to accommodate horizontal beams (B) of any of various sizes and dimensions, as appropriate and necessary based on the range of beam thicknesses or diameters to be accommodated. For example, without limitation, for the maritime industry, the U-shaped bars 20, 30 may be sized and shaped to accommodate beams having thicknesses or diameters of from about 10 inches to about 16 inches, though 12-inch and 14-inch thicknesses and diameters are currently the most common.

Although not shown in the figures, in some embodiments, a handle, such as a rod, bar, or other extended element, may be provided and securely affixed (e.g., welded, etc.) to the front leg 24, 34 of one of the first inverted U-shaped bar 20 or the second inverted U-shaped bar 30, respectively. Such a handle would be manually grasped to facilitate moving the hose rack 10 along the beam (B) for more precise positioning.

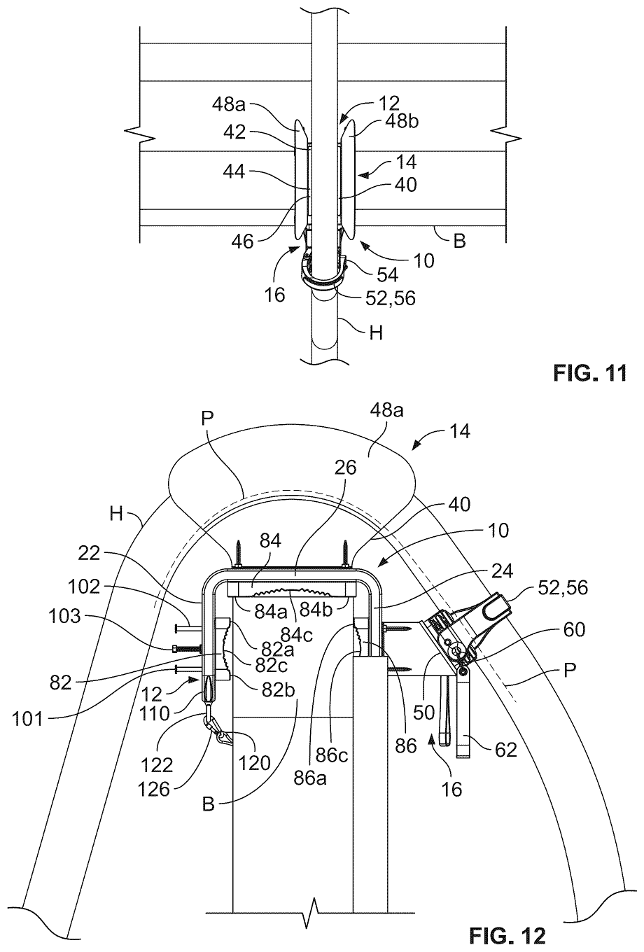

Referring back to FIGS. 1-8, the cradle 14 is formed by a base 40 which is attached to the mounting frame 12 at the arms 26, 36 connecting the legs 22, 24, 32, 34, of the first and second inverted U-shaped bars 20, 30, respectively. The base 40 of the cradle 14 forms a support surface 44 with downward sloping back and front ramps 42, 46 extending in opposite directions from the support surface 44. The cradle 14 also has movement limiting elements, such as the upwardly sloping right and left wings 48a, 48b affixed to opposite sides of the base 40, as shown in FIGS. 1-12. When the hose rack 10 is in use, as shown FIGS. 9-12 and likely best understood while looking at FIG. 11, the hose (H) extends across the horizontal beam (B) and is received in and supported by the cradle 14, extending across and resting on the back ramp 42, support surface 44, and front ramp 46 of the base 40. Sideways movement of the hose (H) relative to the beam (B) and the rack 10 is limited and even minimized by the right and left wings 48a, 48b while the hose (H) is supported by the base 40 of the cradle 14 as just described.

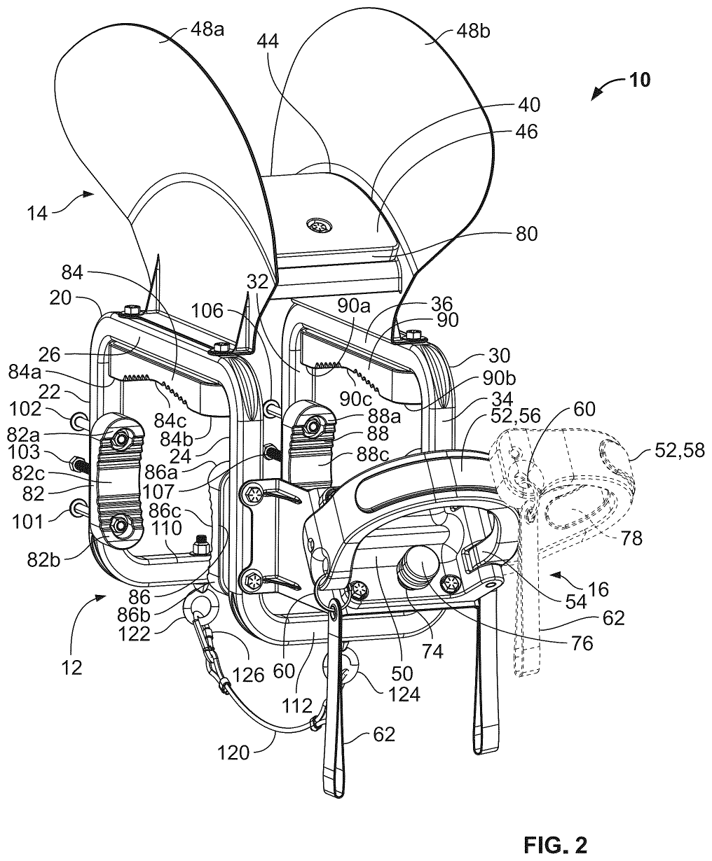

Referring back again to FIGS. 1-8, the clasp assembly 16 includes a downward sloping face 50 with a clasp arm 52. The clasp arm 52 has one end thereof 54 pivotably affixed to the downward sloping face 50. The clasp arm 52 is movable between a closed position 56 shown in solid lines in FIGS. 1-8 and an open position 58 shown in phantom in FIGS. 2-4.

More particularly, when the clasp arm 52 is in its closed position 56, the hose (H) is held against the sloping face 50 to reduce movement and slippage on the hose rack 10 during transfer of flowable materials. When the clasp arm 52 is in its open position 58 (see FIGS. 2-4), prior to commencement of transferring flowable materials, the hose (H) may be positioned on the hose rack 10, across the base 40 of the cradle 14 as described above, before moving the clasp arm 52 to its closed position 56. Alternatively, after transferring of flowable materials is complete, the clasp arm 52 may be moved from its closed position 56 to its open position 58, whereupon the hose (H) may be removed from the hose rack 10.

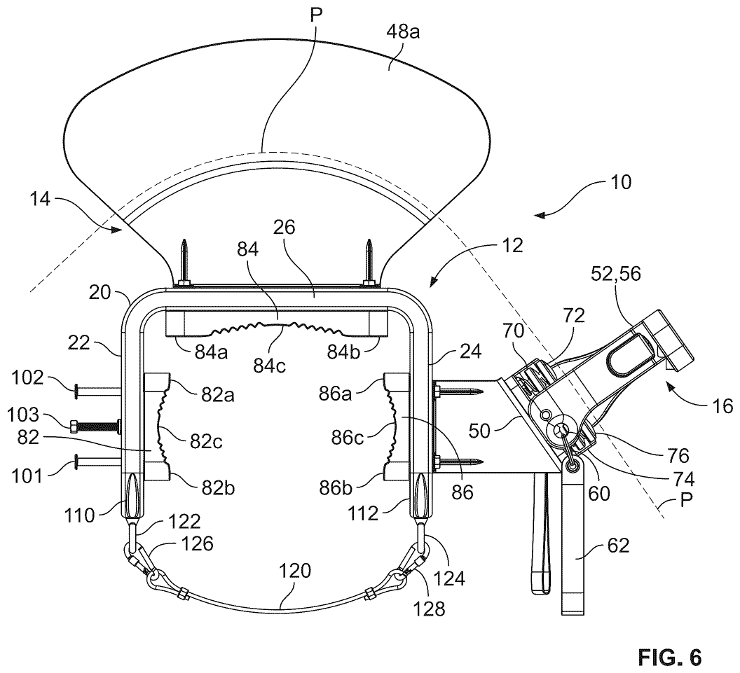

Hoses (H) used to transfer flowable material in the oil and gas industry, as described herein, are generally not fully foldable or bendable in the longitudinal direction, but rather, such hoses (H) are flexible with some stiffness and are susceptible to weakening and even failure after excessive or repeated folding, bending, or crimping. Accordingly, the base 40 of the cradle 14, including the back ramp 42, support surface 44, and front ramp 46, as well as the downward sloping face 50 of the clasp assembly 16 may be configured (sized and shaped) to provide a support path having an angle or curvature which is as close as possible to the natural lay or curvature of the hose (H) when received in the cradle 14 of the hose rack 10. Such a support path (P, in phantom) on the hose rack 10 is most clearly seen and understood by studying the aforesaid features as shown in FIGS. 6 and 12, as well as by looking at the hose (H) shown on the hose rack 10 in FIGS. 10-12. Such a configuration keeps the hose (H) from bending too far on the hose rack 10, and also minimizes or prevents application of too much stress to the hose rack 10 itself and its components when in use. Notwithstanding exemplary configurations of the cradle 14 of a hose rack 10 suitable for use in the offshore oil and gas industry, other exemplary embodiments of the hose rack 10 may have a cradle 14 configured to accommodate hoses (or other elongate articles) useful in other industries and which lie at least partly or entirely flat when not in use but are more, if not entirely, cylindrical when in use.

In some embodiments, at least the first and second inverted U-shaped bars 20, 30 of the mounting frame 12, as well as the right and left wings 48a, 48b of the cradle 14, may be constructed using a weather resistant material, such as machined powder-coated stainless steel, to provide excellent weather-resistant properties to the hose rack 10. Furthermore, components of the clasp assembly 16, such as one or both of the downward sloping face 50 and the clasp arm 52, may also be constructed using a weather resistant material, such as machined powder-coated stainless steel.

For added safety and security, a locking pin 60 may be provided on the clasp arm 52 for securing the clasp arm 52 in its closed position 56. A pull strap 62 may be provided and attached to the locking pin 60 to enable fast and easy release of the locking pin 60 to allow the clasp arm 52 to open and release a hose (H) therein.

At least one or, more effectively, two or more self-adjusting bumpers 70, 74 are positioned behind the clasp arm 52 and affixed to the downward sloping face 50 of the clasp assembly 16, for applying pressure against a hose (H) mounted on the hose rack 10. The pressure applied on the hose (H) by the bumpers 70, 74 reduces slippage of the hose (H) through the assembly 16. The bumpers 70, 74 and the pressure they apply on the hose (H) also allows the clasp assembly 16 to adjust and hold hoses (H) having different diameters without having to change out the entire clasp, assembly 16. Additionally, rubber pads 72, 76 may be provided on the self-adjusting bumpers 70, 74, respectively. A rubber pad or strip insert 78 may also be provided on the inner face of the clasp arm 52 (see FIGS. 2, 3, and 8) to provide additional grip on the hose (H). In some embodiments, the rubber pads 72, 76, 78 are the same type of jacket (coating) material that is provided on the exterior of the hose (H) for providing as much friction as possible. When the time comes to release the hose (H) from the hose rack 10, the personnel will pull the strap 62 associated with the locking pin 60 and the clasp arm 52 will quickly release and move from its closed position 56 to its open position 58, thus freeing the hose (H).

In some embodiments, the base 40 of the cradle 16 is also made of rubber material, or overlayed with a strip or coating 80 of rubber material which may be the same as the coting material of the hose (H). While the base 40 or a strip or coating 80 thereon does not provide the same kind of grasp on the hose (H) as does the clasp arm 52, the friction generated from the rubber material touching the jacket or coating of the hose (H) will assist in keeping the hose from jumping around in the hose rack 10.

Offshore supply vessels in the Gulf of Mexico have headache racks (horizontal beams (B)) of different shapes and diameters. Thus, the hose rack 10 includes one or more securing features which secure the hose rack 10 to these various types and shapes of headache racks (B). It is fair to say that about 90% of the offshore supply vessels have cylindrical headache racks (B). The other 10% have square headache racks (B). More particularly, to accommodate mounting the hose rack 10 on elongated apparatus having any of various shapes and sizes (e.g., on both cylindrical and non-cylindrical headache racks (beams) (B), having various diameters or widths), one or more securing features are provided, such as the rubber contact pads 82, 84, 86, 88, 90, 92 shown in the figures, each of which is moveably affixed to the inner surface of a respective one of each of the legs 22, 24, 32, 34 and the arms 26, 36 connecting them, of the first and second inverted U-shaped bars 20, 30. While the rubber contact pads 82, 84, 86, 88, 90, 92 are visible to some degree in all of FIGS. 1-6 and 7-12, their configuration is most clearly shown in FIG. 6. In particular, each rubber contact pad 82, 84, 86, 88, 90, 92 has a flat end section 82a, 82b, 84a, 84b, 86a, 86b, 88a, 88b, 90a, 90b, 92a, 92b at each end thereof, respectively, and an intermediate recessed or convex section 82c, 84c, 86c, 88c, 90c, 92c therebetween. The flat sections 82a, 82b, 84a, 84b, 86a, 86b, 88a, 88b, 90a, 90b, 92a, 92b of the rubber contact pads 82, 84, 86, 88, 90, 92 conform to and grip non-cylindrical headache racks (B) such as those having a square or rectangular cross-section (see, e.g., FIGS. 10-12), while the intermediate recessed or convex sections 82c, 84c, 86c, 88c, 90c, 92c conform to and grip cylindrical headache racks (B) having a round cross-section.

Additionally, a pair of guide pins 101, 102 and a forcing screw 103 are inserted through the back leg 22 of the first inverted U-shaped bar 20 and into the rubber contact pad 82 affixed thereto for adjusting the position of the rubber contact pad 82 and applying force against the headache rack (B). Another pair of guide pins 105, 106 and another forcing screw 107 are inserted through the back leg 32 of the second inverted U-shaped bar 30 and into the rubber contact pad 88 affixed thereto. The guide pins 101, 102, 105, 106 and the forcing screws 103, 107 are used to adjust the position of the respective rubber contact pads 82, 88 and apply force against the headache rack (B). This force along with the friction created thereby will retain the hose rack 10 in the selected position on the headache rack (B) during the duration of the transfer of flowable material through the hose (H).

As shown most clearly in FIGS. 1-4, 6, and 8, an added safety feature may be included to for secondary retention, i.e., keeping the hose rack 10 mounted on the horizontal beam (B) (headache rack) in the event that the hose rack 10 becomes loose or jarred from its initial installed position on the beam (B). In some embodiments, the mounting frame 12 of the hose rack 10 may include a back connecting arm 110 which connects the bottom ends of the back legs 22, 32 of the first and second inverted U-shaped bars 20, 30, respectively, to one another. Similarly, a front connecting arm 112 may connect the bottom ends of the front legs 24, 34 of the first and second inverted U-shaped bars 20, 30, respectively, to one another. In embodiments of the hose rack 10 which have a mounting frame 12 that includes the aforesaid back and front connecting arms 110, 112, the secondary safety feature may include a tether, such as a vinyl-coated braided stainless steel tether 120 which is removably connected to both of the back and front connecting arms 110, 112 so that the tether 120 extends underneath the horizontal beam (B). For example, without limitation, an eye bolt 122, 124 may be affixed to each of the back and front connecting arms 110, 112, and a carabiner 126, 128 used to connect each end of the tether 120 to a respective one of the eye bolts 122, 124. This additional safety feature will help avoid anything coming loose and going into the water, which is also an important consideration.

Because of the hose rack's 10 modular design, development of interchangeable parts to suit different needs or industries is easily possible. For example, the rubber contact pads 82, 84, 86, 88, 90, 92 affixed to the first and second inverted U-shaped bars 20, 30 for contacting and siting on the headache rack (B), could be replaced with similar securing features sized and shaped to secure the hose rack to a handrail, or some other type of elongated apparatus or portion thereof such as, but not limited to, a rack, a railing, or even the top rim (edge or portion) of a wall, fence, bulkhead, panel, partition, etc., and other similarly shaped apparatus. It is further contemplated and within the scope of the present disclosure that the clasp assembly 16 and clasp arm 52 of the rack described herein could be substituted with differently sized and shaped components to suit different needs (e.g., such as holding and securing elongate articles other than a material transfer hose, as explained below).

Additionally, the rack described and contemplated herein is not limited to use for holding and securing a hose, but rather features of the rack may be modified and adapted for holding and securing other elongate articles and equipment such as, without limitation, electric cords, power cables, welding leads, air hoses and conduits, tubing, and the like. For example, a modified “V” design for the cradle of the rack could be useful in shipyards or offshore demolition projects to confine and secure extension cords, 220v or greater power cables, welding leads, etc. This would keep such cords and leads from sitting on potentially sharp deck plating or other objects that could create dangerous environments for personnel.

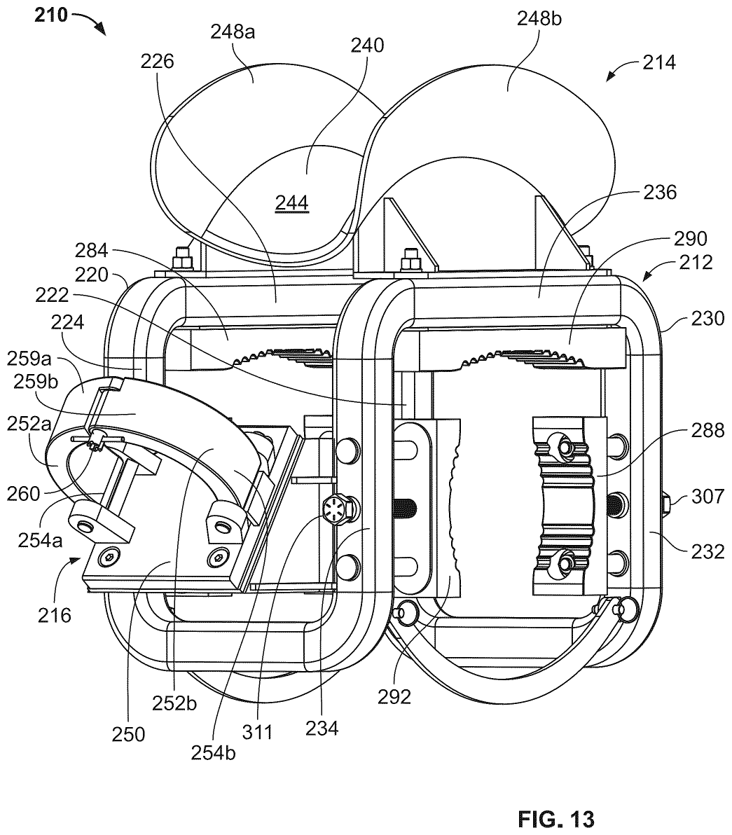

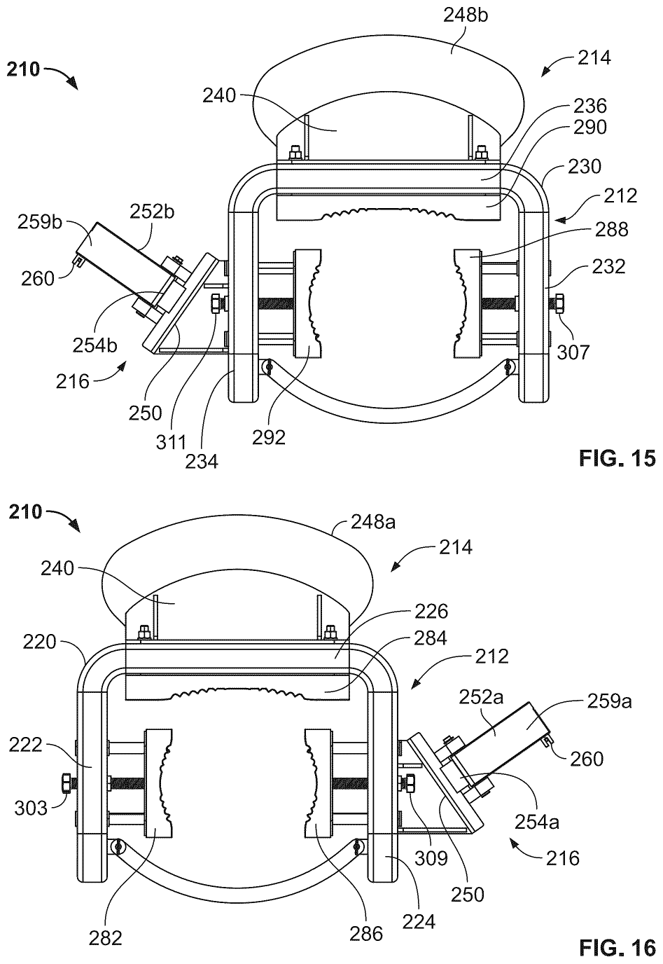

Referring now to FIGS. 13-17, another exemplary embodiment of the hose rack 210 is shown and will be described next. Although each and every feature may not be specifically named and described below, it should be understood that all features of the next exemplary embodiment of the hose rack 210 (FIGS. 13-17) correspond to and operate analogously to those discussed above in connection with the first exemplary embodiment of the hose rack 10 (FIGS. 1-10).

The following description of the next exemplary embodiment of the hose rack 210 shown in FIGS. 13-17 focuses on modified and/or improved features. The features of the hose rack 210 are indicated in FIGS. 13-17 with the same reference numbers used for corresponding features of the first embodiment of FIGS. 1-12, but increased by 200.

With reference now to FIGS. 13-17, the next exemplary embodiment of the hose rack 210 generally includes the same or analogous components as the first embodiment. More particularly, the hose rack 210 includes a mounting frame 212 which is sized and shaped to rest on and extend downward on opposite sides (i.e., simultaneously on the water facing side and on the deck side) of the horizontal beam (B). The elements of the mounting frame 212 are sized, shaped, and assembled to enable the hose rack 210 to accommodate horizontal beams having any of several typical shapes used in the relevant industry (e.g., cylindrical and having a round cross-sectional shape, non-cylindrical and having a rectilinear cross-sectional shape, etc.), as well as different sized thicknesses and diameters as described above for the first embodiment.

Additionally, the second exemplary embodiment of the hose rack 210 includes a cradle 214 which is affixed to the top of the mounting frame 212. The cradle 214 is sized and shaped to receive and support a hose (not shown in FIGS. 13-17, but see FIGS. 9-12 showing a hose supported on the first embodiment) which would lie substantially transversely across the horizontal beam. Finally, a clasp assembly 216 is affixed to and extends from the front of the mounting frame 212 of the hose rack 210 for receiving and holding the hose.

The mounting frame 212 of the hose rack 210 shown in FIGS. 13-17 includes a first inverted U-shaped bar 220 and a second inverted U-shaped bar 230 which is spaced from and aligned with the first inverted U-shaped bar 220. In use, the mounting frame 212 and, therefore, the hose rack 210, rests stably on the horizontal beam, with the rear legs 222, 232 of the first and second inverted U-shaped bars 220, 230, respectively, extending downward on the water facing side of the horizontal beam, while the front legs 224, 234 of the first and second inverted U-shaped bars 220, 230, respectively, simultaneously extending downward on the opposite deck side of the horizontal beam. A transverse arm 226 connects the rear and front legs 222, 224 of the first inverted U-shaped bar 320, and a transverse arm 236 connects the rear and front legs 232, 234 of the second inverted U-shaped bar 230. In use, each of the connecting arms 226, 236 of the respective first and second inverted U-shaped bars 220, 230 rests across the top of the beam, spaced apart from one another, and define the top of the mounting frame 212.

To facilitate securely mounting the hose rack 210 on both cylindrical and non-cylindrical headache racks (beams) of various thicknesses and diameters as mentioned above, each of the rubber contact pads 282, 284, 286, 288, 290, 292 (securing features) is movably affixed to the inner surface of each of the legs 222, 224, 232, 234 and the connecting arms 226, 236, respectively, of the first and second inverted U-shaped bars 220, 230. The configuration of the rubber contact pads 282, 284, 286, 288, 290, 292 is most clearly shown in FIGS. 13-16 and is the same as for the rubber contact pads 82, 84, 86, 88, 90, 92 described above for the first embodiment of the hose rack 10 (see also FIGS. 1, 2, and 6).

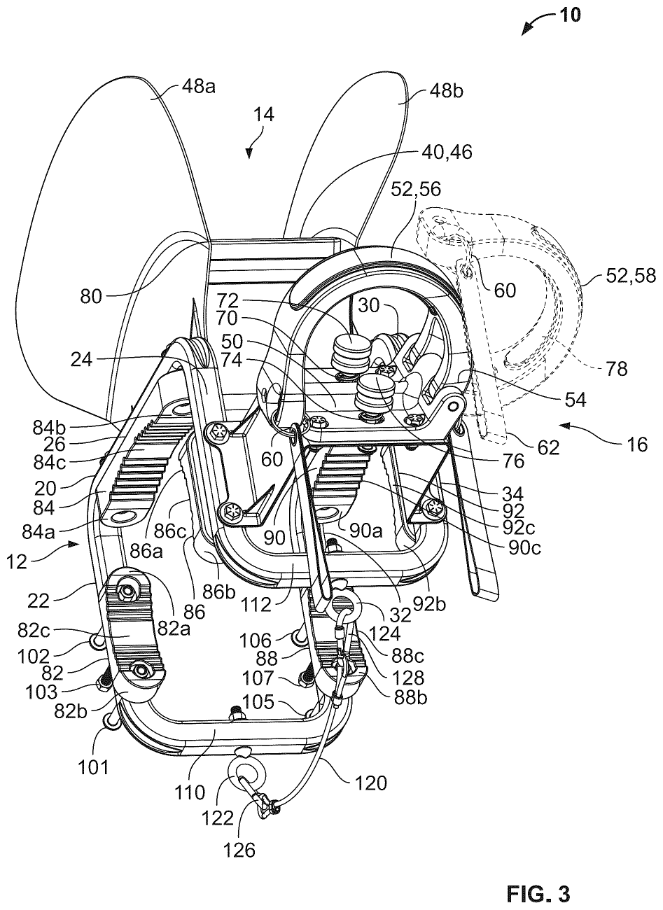

The mechanism of the first embodiment of the hose rack 10 for adjusting the positions of rubber contact pads and cause them each to press against the headache rack (beam), thereby securely holding the hose rack 10 on the headache rack during use, are modified and moved to the front of the present second exemplary embodiment of the hose rack 210. More specifically, in the first embodiment of the hose rack 10 forcing screws 103, 107 are each inserted, respectively, through the back legs 22, 32 of the first and second inverted U-shaped bars 20, 30 and into the rear rubber contact pads 82, 88 (see FIGS. 3 and 6). As shown in FIGS. 13-17, in the second exemplary embodiment of the hose rack 210, instead of being inserted through the back legs 222, 232, forcing screws 309, 311 are inserted through the front legs 224, 234, respectively, and into the front rubber contact pads 286, 292 (i.e., instead of, or in addition to, having forcing screws 303, 307 inserted through the back legs 232, 234). This puts the forcing screws 309, 311 in a location which is more easily accessible by users and operators who would typically be standing in front of the hose rack 210 while installing and operating the hose rack 210 and clasp assembly 216.

More specifically, as shown in FIGS. 13-17, a first forcing screw 309 is inserted through the front leg 224 of the first inverted U-shaped bar 220 and into the rubber contact pad 286 affixed thereto. A second forcing screw 311 is inserted through the front leg 234 of the second inverted U-shaped bar 230 and into the rubber contact pad 292 affixed thereto. Of course, it is possible, in alternative embodiments of the hose rack 210, to include forcing screws 303, 307, 309, 311 which are inserted through the back legs 222, 232 and the front legs 224, 234, of the first and second inverted U-shaped bars 220, 230, respectively, for added flexibility and security when mounting the hose rack 210 onto a headache rack (horizontal beam). In some embodiments, the forcing screws 303, 307 inserted through the back legs 222, 232 of the respective of the first and second inverted U-shaped bars 220, 230 may be static and not adjustable, such as posts or pins (not shown per se). Furthermore, regardless of whether the forcing screws 303, 307, 309, 311 are inserted through the back legs 222, 232 or through the front legs 224, 234 (or both), of the of the first and second inverted U-shaped bars 220, 230, respectively, each of the forcing screws 103, 107, 303, 307, 309, 311 should be made of a material and have a diameter which is capable of supporting the weight of the hose rack 10, 210 with bending, deforming, or failing.

As in the first embodiment, the cradle 214 of the second exemplary embodiment of the hose rack 210 is formed by a base 240 which is attached to the mounting frame 212 and forms a support surface 244. The cradle 214 also includes upwardly sloping right and left wings 248a, 248b which are affixed to opposite sides of the base 240. In comparison with the right and left wings 48a, 48b provided on the cradle 214 of the first embodiment of the hose rack 10 (see, e.g., FIGS. 1, 2, and 9), while still upwardly sloping to receive the hose therebetween, the right and left wings 248a, 248b of the second embodiment of the hose rack 210 are smaller and extend a shorter distance from the cradle 214. The smaller right and left wings 248a, 248b still provide support and restrict unwanted sideways (lateral) movement of a hose lying substantially transversely across the beam (B), but require less material for manufacture (i.e., reduces material costs) and desirably and beneficially reduces the overall weight of the hose rack 210.

It should be understood that the movement limiting elements are not required to be planar wings 48a, 48b, 248a, 248b as shown and described for above-described embodiments of FIGS. 1-12 and 13-17. Rather, the movement limiting elements may be any size and shape which will effectively inhibit and limit sideways movement of the hose (H). For example, without limitation, the movement liming elements of the cradle may comprise a plurality of posts, pegs, or even curved rib-like elements (not shown), preferably provided on both sides of the base and extending upwardly or sloping upwardly from the base of the cradle. Modifying the movement limiting elements from the wings 48a, 48b, 248a, 248b (described hereinabove for the first and second exemplary embodiments of the hose rack 10, 210) to a plurality of posts, pegs, or ribs, may advantageously further reduce the overall weight of the hose rack 10, 210. However, care should be taken to select materials and dimensions which will provide movement limiting elements strong enough to support and limit the sideways movement of an elongate article without mechanical deformation or failure.

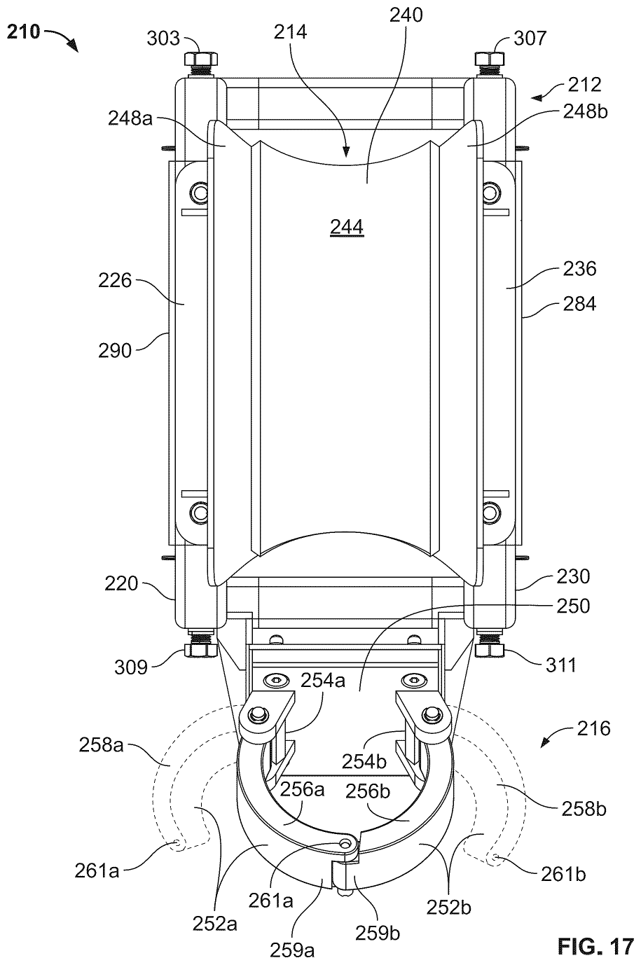

The clasp assembly 216 of the hose rack 210 has a “clamshell” design, shown most clearly in FIGS. 13, 14, and 17, which includes a downward sloping face 250 and, instead of one clasp arm, two clasp arms 252a, 252b are provided. As will be described in more detail below, the two clasp arms 252a, 252b are movable and cooperate to secure and hold a hose, which lies across the cradle 214, against the downward sloping face 250 in between the clasp arms 252a, 252b. More particularly, each of the first and second clasp arms 252a, 252b has one end thereof 254a, 254b pivotably affixed to the downward sloping face 250. Each of the clasp arms 252a, 252b is pivotably movable, respectively, between a closed position 256a, 256b, respectively, shown in solid lines in FIG. 17 and an open position 258a, 258b, respectively, shown in phantom in FIG. 17.

When the clasp arms 252a, 252b are in their closed positions 256a, 256b (solid, see FIG. 17), the hose is held against the sloping face 250 to reduce movement and slippage on the hose rack 210 during transfer of fluid and/or flowable materials. When the clasp arms 252a, 252b are in their open positions 258a, 258b (phantom, see FIG. 17), prior to commencement of transferring fluid and/or flowable materials, the hose may be positioned on the hose rack 210, across the base 240 of the cradle 214 as previously described, before moving the clasp arms 252a, 252b to their closed positions 256a, 256b (solid, see FIG. 17). Similarly, after the transferring of fluid and/or flowable materials is complete, the clasp arms 252a, 252b may be moved from their closed positions 256a, 256b to their open positions 258a, 258b, whereupon the hose may be removed from the hose rack 210. Since the first and second clasp arms 252a, 252b of the clasp assembly 216 are shorter in length than is required when only a single clasp arm 52 is provided (as in the first embodiment), movement between the closed positions 256a, 256b and open positions 258a, 258b, respectively requires less time, which may be helpful during actual use.

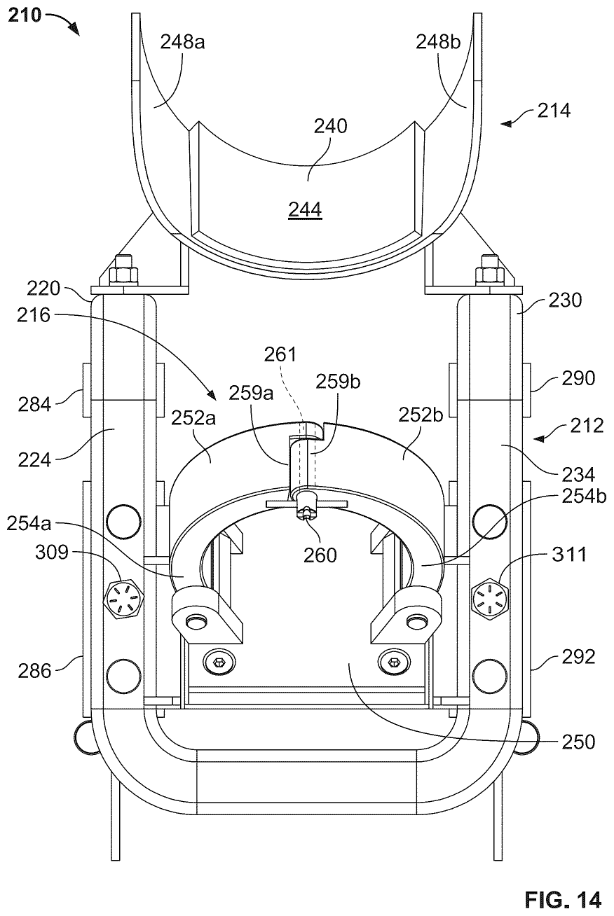

For added safety and security, the clasp arms 252a, 252b are provided with a locking mechanism which includes a locking pin 260 which is sized and shaped to be received into bore holes 261a, 261b provided at the respective free end 259a, 259b of each of the first and second clasp arms 252a, 252b that is opposite the respective pivotably affixed ends 254a, 254b thereof. In use, when the clasp arms 252a, 252b are in their closed positions 256a, 256b, the respective free ends 259a, 259b overlap and mate such that the respective bore holes 261a, 261b are aligned with one another in an approximately vertical orientation (see aligned bore holes 261 shown in phantom in FIG. 14) and receive the locking pin 260 through both of the aligned bore holes 261a, 261b (261, FIG. 14).

Unlike the locking pin 60 of the first embodiment of the hose rack 10 that is inserted in a substantially horizontal orientation (see FIGS. 1 and 6), the aligned bore holes 261a, 261b (in phantom 261, FIG. 14) of the mated free ends 259a, 259b of the respective clasp arms 252a, 252b receive the locking pin 260 in an approximately vertical orientation, which makes insertion and, particularly, withdrawal of the locking pin 260 easier.

In some embodiments, to further assist with rapid withdrawal of the locking pin 260 from the aligned bore holes 261a, 261b (in phantom 261, FIG. 14) when the first and second clasp arms 252a, 252b are in their closed positions 256a, 256b, the locking pin 260 may be spring loaded (not shown per se). Additionally, a pull strap or string (not shown) may be provided and attached to the locking pin 260 to provide an element which is easy to grasp which will enhance the fast and easy release of the locking pin 260 to allow the clasp arms 252a, 252b to separate and open, thereby releasing a hose being held thereby. When the time comes to release the hose from the hose rack 210, the personnel may grasp a protruding end of the locking pin 260 (or the pull strap, if provided, or activate the spring of a spring-loaded locking pin) and the clasp arms 252a, 252b will quickly release and move to their open positions 258a, 258b (see FIG. 17), thus rapidly freeing the hose.

It will be understood that the embodiments of the present invention described and contemplated herein are merely exemplary and that persons skilled in the relevant art may make variations and modifications thereto without departing from the spirit and scope of the invention. All such variations and modifications are intended to be included within the scope of the presently disclosed and contemplated invention.

We claim:

1. A rack for supporting and securing an elongate article on an elongated apparatus of a water borne vessel for transferring materials to and from one or more sources and destinations, at least one of which comprises the water borne vessel, the rack comprising,
a mounting frame having a top and including at least one rear element extending downward from the top and at least one front element extending downward from the top and spaced from the at least one rear element, the mounting frame being sized and shaped to enable the top to rest on the elongated apparatus while the at least one rear element extends downward on one side of the elongated apparatus and the at least one front element extends downward on an opposite side of the elongated apparatus;
a cradle which is sized and shaped to receive and support the elongate article while lying substantially transversely across the elongated apparatus, the cradle being affixed to the top of the mounting frame and including movement limiting elements which limit sideways movement of the elongate article while supported thereon; and
a clasp assembly which is affixed to and extends from a front of the mounting frame for receiving and holding the elongate article and reducing movement of the elongate article while lying substantially transversely across the elongated apparatus.

2. The rack of claim 1, wherein the mounting frame further includes one or more securing features which contact and grip an elongated apparatus when the hose rack is mounted thereon.

3. The apparatus of claim 1, wherein the mounting frame comprises:
a first inverted U-shaped bar having a rear leg, a front leg, and a transverse arm connecting the rear and front legs of the first inverted U-shaped bar, and
a second inverted U-shaped bar which is spaced from and aligned with the first inverted U-shaped bar, the second inverted U-shaped bar having a rear leg, a front leg, and a transverse arm connecting the rear and front legs of the second inverted U-shaped bar, wherein, when the rack is in use,
the transverse arms of both of the first and second inverse U-shaped bars rest on the elongated apparatus,
the at least one rear element of the mounting frame comprises the rear legs of both of the first and second inverted U-shaped bars which both extend downward on one side of the elongated apparatus, and
the at least one front element of the mounting frame comprises the front legs of each of the first and second inverted U-shaped bars, the front legs extending downward on an opposite side of the elongated apparatus.

4. The rack of claim 3, wherein the mounting frame further comprises a back connecting arm and a front connecting arm, wherein
the back connecting arm connects to each of the back legs of each of the respective first and second inverted U-shaped bars, at bottom ends of each of the back legs which are opposite the transverse arms; and
the front connecting arm connects to each of the front legs of each of the respective first and second inverted U-shaped bars, at ends thereof opposite the transverse arms.

5. The rack of claim 4, further comprising a tether which is removably connected to each of the back and front connecting arms of the mounting frame, and when the rack is mounted on an elongated apparatus, the tether extends underneath the elongated apparatus, on a side of the elongated apparatus opposite the transverse arms of each of the first and second inverse U-Shaped bars.

6. The rack of claim 3, wherein the mounting frame further includes one or more moveable securing features which contact and grip an elongated apparatus when the hose rack is mounted thereon,
wherein each of the one or more moveable securing features is moveably affixed to the mounting frame, on an inner surface of a respective one of the rear leg, the front leg, or the transverse arm of either the first inverted U-shaped bar or the second inverted U-shaped bar, by at least one guide pin attached to the moveable securing feature and inserted through the respective one of the rear leg, the front leg, or the transverse arm to which the moveable securing feature is moveably affixed, wherein each of the one or more moveable securing features is adjustable, relative to the respective one of the rear leg, the front leg, or the transverse arm to which it is moveably connected, by at least one forcing screw which is in contact with the moveable securing feature and inserted through the respective one of the rear leg, the front leg, or the transverse arm to which it is moveably connected, and
wherein when a forcing screw is operated to adjust the position of its respective movable securing feature closer to an elongated apparatus on which the rack is being mounted, the moveable securing feature will apply force against, and increase friction with, the elongated apparatus and retain the rack in a selected position on the elongated apparatus during its use.

7. The rack of claim 6, wherein at least one of the one or more moveable securing features comprises a rubber pad having one or more shaped sections selected from a flat section, a convex section, or a combination thereof, for enabling securely mounting the rack to elongated apparatuses having any of various shapes and sizes.

8. The rack of claim 7, wherein the one or more shaped sections of the rubber pad include a first flat end section at one end of the rubber pad, a second flat end section at an opposite end of the rubber pad, and an intermediate convex section between the first and second flat sections.

9. The rack of claim 6, wherein the mounting frame further includes one or more unmovable securing features which contact and grip an elongated apparatus when the hose rack is mounted thereon,
wherein each of the one or more unmovable securing features is statically affixed to the mounting frame, on an inner surface of a respective one of the rear leg, the front leg, or the transverse arm of either the first inverted U-shaped bar or the second inverted U-shaped bar, and
wherein, optionally, at least one of the one or more unmovable securing features has one or more shaped sections selected from a flat section, a convex section, or a combination thereof.

10. The rack of claim 6, wherein the one or more moveable securing features comprise a plurality of movable security features, each of which comprises a rubber pad having at least: a first flat end section at one end thereof, a second flat end section at an opposite end thereof, and an intermediate convex section between the first and second flat sections,
wherein the plurality of movable security features includes one or more of:
(a) a first rubber pad which is moveably affixed on an inner surface of the rear leg of the first inverted U-shaped bar by at least one guide pin inserted through the rear leg of the first inverted U-shaped bar, and is adjustable by at least one forcing screw inserted through the rear leg of the first inverted U-shaped bar,
(b) a second rubber pad which is moveably affixed on an inner surface of the rear leg of the second inverted U-shaped bar by at least one guide pin inserted through the rear leg of the second inverted U-shaped bar, and is adjustable by at least one forcing screw inserted through the rear leg of the second inverted U-shaped bar,
(c) a third rubber pad which is moveably affixed on an inner surface of the front leg of the first inverted U-shaped bar by at least one guide pin inserted through the front leg of the first inverted U-shaped bar, and is adjustable by at least one forcing screw inserted through the front leg of the first inverted U-shaped bar, and
(d) a fourth rubber pad which is moveably affixed on an inner surface of the front leg of the second inverted U-shaped bar by at least one guide pin inserted through the front leg of the second inverted U-shaped bar, and is adjustable by at least one forcing screw inserted through the front leg of the second inverted U-shaped bar.

11. The rack of claim 10, wherein the mounting frame further includes a first unmovable securing feature and a second unmovable securing feature, each of which contacts and grips an elongated apparatus when the hose rack is mounted thereon,
wherein the first unmovable securing feature is statically affixed on an inner surface of the transverse arm of the first inverted U-shaped bar, and
wherein the second unmovable securing feature is statically affixed on an inner surface of the transverse arm of the second inverted U-shaped bar, and
wherein, optionally, either or both of the first and second unmovable security features has one or more shaped sections selected from a flat section, a convex section, or a combination thereof.

12. The rack of claim 1, wherein the cradle comprises:
a base which is attached to the top of the mounting frame and forms a support surface for supporting an elongate article thereon, and
movement limiting elements comprising an upwardly sloping right wing affixed to and extending from one side of the base, and an upwardly sloping left wing affixed to and extending from an opposite side of the base,
wherein the base and the upwardly sloping right and left wings of the cradle are sized to allow the elongate article to rest on the support surface of the base, in between the right and left wings, and limit the sideways movement of the elongate article.

13. The rack of claim 12, wherein the base of the cradle includes a downward sloping back ramp extending from the support surface and a downward sloping front ramp extending from the support surface in a direction opposite from the back ramp, wherein the back ramp, support surface positioned intermediate the back and front ramps, and the front ramp together form a support path for an elongate article lying thereon, the support path providing additional support which reduces damage to the elongate article from bending too far while on the rack and minimizes stress on the rack.

14. The rack of claim 13, wherein the support path of the cradle has an angle or curvature which is as close as possible to an unstrained and natural curvature of the elongate article when on the cradle of the hose rack.

15. The rack of claim 13, wherein one or more rubber pads are provided on one or more of each of the downward sloping back ramp, the support surface, and the downward sloping front ramp of the cradle, wherein each of the one or more rubber pads provides additional grip on an elongate article received and lying on the cradle.

16. The rack of claim 1, wherein the clasp assembly comprises:
a downward sloping face which is oriented and sloped to provide additional support to an elongate article lying across and supported on the cradle, and
at least one clasp arm, each of which has a pivot end pivotably attached to the downward sloping face and each of which is moveable between an open position and a closed position, each of the at least one clasp arms also having a free end opposite the pivot end and which is adapted for locking the at least one clasp arm in the closed position,
wherein, when the at least one clasp arm is in its open position, an elongate article lying on and supported by the cradle also lies on and is supported by the downward sloping face, and when the at least one clasp arm is in its closed position, the elongate article is securely held on the rack and its movement is limited relative to the rack.

17. The rack of claim 16, wherein one or more rubber pads are provided on one or more of each of the at least one clasp arms and the downward sloping face of the clasp assembly, wherein each of the one or more rubber pads provides additional grip on an elongate article received in and held by the at least one clasp arms when in their closed positions.

18. The rack of claim 16, wherein the at least one clasp arm includes either:
a single clasp arm wherein the locking end includes a locking pin for locking the single clasp arm in its closed position, or
a first clasp arm, a second clasp arm, and a locking pin, wherein the respective pivot end of each of the first clasp arm and the second clasp arm is pivotably attached to the downward sloping face, the respective pivot end of each of the first clasp arm and the second clasp arm has a bore hole therethrough, and wherein, when the first and second clasp arms are both in their respective closed positions, the free ends of the first and second clasp arms mate and the bore holes align with one another and are sized and shaped to receive the locking pin through both bore holes, thereby locking the first and second clasp arms together in their closed positions.

19. The rack of claim 18, wherein the clasp assembly further includes a pull strap attached to the locking pin for quick release of the locking pin and rapid movement of the single clasp arm to its open position.

20. The apparatus of claim 1, wherein the elongated apparatus on which the rack is secured is selected from a beam, a bar, a rack, a railing, and a top rim of a wall, fence, bulkhead, panel, or partition, and the elongate article being held and secured on the rack is selected from a flexible conduit, a hose, a cord, a cable, a tube, and an electric cord, and a power cable.
